(19) United States
(12) Patent Application Publication
(10) Pub. No.: US 2023/0204986 A1
(43) Pub. Date: Jun. 29, 2023

(54) NANOSCALE-RECONFIGURABLE METASURFACES ON-DEMAND WITH CORRELATED OXIDES

(71) Applicants: University of Georgia Research Foundation, Inc., Athens, GA (US); Purdue Research Foundation, West Lafayette, IN (US)

(72) Inventors: Neda Alsadat Aghamiri, Athens, GA (US); Yohannes Abate, Athens, GA (US); Shriram Ramanathan, West Lafayette, IN (US)

(21) Appl. No.: 18/071,688

(22) Filed: Nov. 30, 2022

Related U.S. Application Data
(60) Provisional application No. 63/285,163, filed on Dec. 2, 2021.

(51) Int. Cl. G02F 1/00; G02F 1/03

(52) U.S. Cl. CPC G02F 1/0018; G02F 1/0305

(57) ABSTRACT

A metasurface for propagating phonon polaritons includes correlated oxide on a substrate and a wiring pattern of predetermined geometric shape on the surface thereof. There is a flake of van der Waals phononic exfoliable material on top of the wiring pattern/region. The wiring pattern may be formed by c-AFM or any other appropriate methods.

### CROSS REFERENCE TO RELATED APPLICATIONS

This application is a non-provisional of and claims the priority benefit of Application Ser. No. 63/285,163, filed Dec. 2, 2021, pending, which application is hereby incorporated by this reference in its entirety.

### STATEMENT REGARDING FEDERALLY SPONSORED RESEARCH OR DEVELOPMENT

This invention was made with government support under Grant No. FA9559-16-1-0172, awarded by Air Force Office of Scientific Research (AFOSR). The Government has certain rights in the invention.

### TECHNICAL FIELD

This disclosure relates to reconfigurable hyperbolic correlated oxide metasurfaces, and more particularly to correlated oxide meta-structures, with on-demand and multimode programming of polaritons at the nanoscale.

### BACKGROUND

Metasurfaces are the assembly of ultrathin and subwavelength nanostructures that could offer tremendous promises to manipulate light-matter interactions in an unprecedented way^{1,2}. Recent advances in hybridizing metasurfaces with optically active materials and correlated oxides have particularly attracted widespread attention due to the ability to engineer novel functionalities that are actively tunable. Tunable polaritonic metasurfaces have been pursued for reconfigurable nano-optic functionalities in compact devices³. One strategy is to apply the phase-change media as the substrate of emerging van der Waal nanomaterials, thus efficiently modulating the phonon polariton (PhPs)⁴⁻⁶. For instance, the hyperbolic PhPs (HPhPs), i.e. the PhPs following a hyperbolic dispersion in anisotropic crystals with at least two components of polarizability tensor of different signs, can be changed via the phase change substrate^{3,7,8}. So far, such tunable polaritons via phase change materials that rely on the temperature as the seed introduces loss, as the phonon lifetime is reduced when the temperature and hence the phonon-phonon scattering events increase. In addition, this route suffers from inaccessibility of nanoscale manipulation due to limited way for localized thermal manipulations. As a result, reconfigurability of nanopolaritonic metasurface remains limited.

### SUMMARY

In accordance with the purpose(s) of this invention, as embodied and broadly described herein, this invention, in one aspect, relates to a device having a metasurface for propagating phonon polaritons, the device comprising a substrate; a patterned correlated oxide on the substrate; and a van der Waals phononic exfoliable material on the patterned correlated oxide.

In another aspect, a method of manufacturing a metasurface comprises providing a substrate; depositing a correlated oxide on the substrate; patterning the correlated oxide via lithography; and depositing a van der Waals phononic exfoliable material over the patterned correlated oxide.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIGS. 1A-1D show a meta-structure consists of SNO-conductive written region and hBN flake.

FIGS. 2A-2I show tailoring local conductivity of SNO.

FIGS. 3A-3H shows near-field images of SNO showing local conductivity changes at different temperatures.

FIGS. 4A-4B illustrate local conductivity manipulation by controlling oxygen dopants via applied field, temperature, and hydrogen incorporation.

FIGS. 5A-5B show conductive writing manipulation by temperature change compared to SNO.

FIGS. 6A-6I show several meta-structures.

FIGS. 7A-7H shows second harmonic near-field amplitude s₂ and phase φ₂ images of the SNO-hBN structures at various wavelengths.

FIGS. 8A-8F show anisotropic propagation of polaritons in hBN at various wavelengths.

FIGS. 9A-9L show hyperbolic polaritons in α-MoO₃ at different wavelengths.

### DETAILED DESCRIPTION

Correlated oxides provide enormous advantages to engineer meta-devices due to their highly tunable optical and electronic properties⁹⁻¹¹. Among these, the rare-earth nickelates (RNiO₃, R=rare-earth element) display a rich phase diagram of structural and physical properties¹²⁻¹⁵, controllable via various approaches, including doping, temperature, atomic vacancies, electrical bias, etc. Hence, those media have been investigated for applications as configurable nanoelectronics, fuel cells, and memristor devices¹⁶⁻²⁰. SmNiO₃ (SNO) nickelate is unique in the rare-earth nickelate family because it displays phase transition above room temperature and is extremely sensitive to the orbital occupancy of electrons and carrier doping, exhibiting a huge change (more than eight orders of magnitude) in electrical resistivity and an order of magnitude in optical band gap during metal-insulator phase transition (MIT)²³. These properties enable SNO enormously and reversibly to change its refractive index over ultrabroad frequency ranges, which have been utilized for nanophotonics applications including the electro-optic modulators for controllable scattering characteristics²³ while tremendous new opportunities remain unveiled.

Accordingly, disclosed herein is a correlated oxide meta-structure with on-demand and multimode programming of polaritons at the nanoscale, which is largely tunable via field generated oxygen vacancies, hydrogen doping, and/or temperature modulation. Presented herein is the characterization as well as manipulation of optical properties of SNO. Also provided are case studies of two prototypical hyperbolic van der Waals crystals hexagonal boron nitride (hBN) and alpha-phase molybdenum trioxide (α-MoO₃), which showcases the rich dispersion engineering of HPhPs, enabling diverse control and patterning of PhPs.

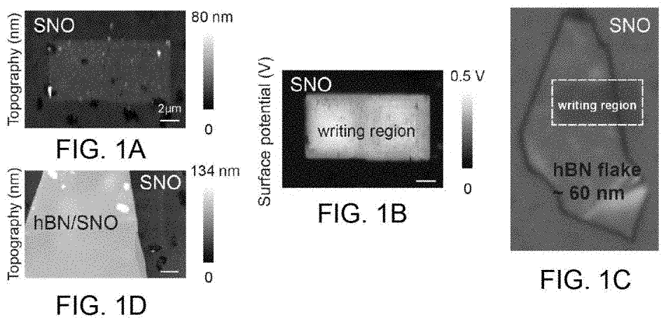

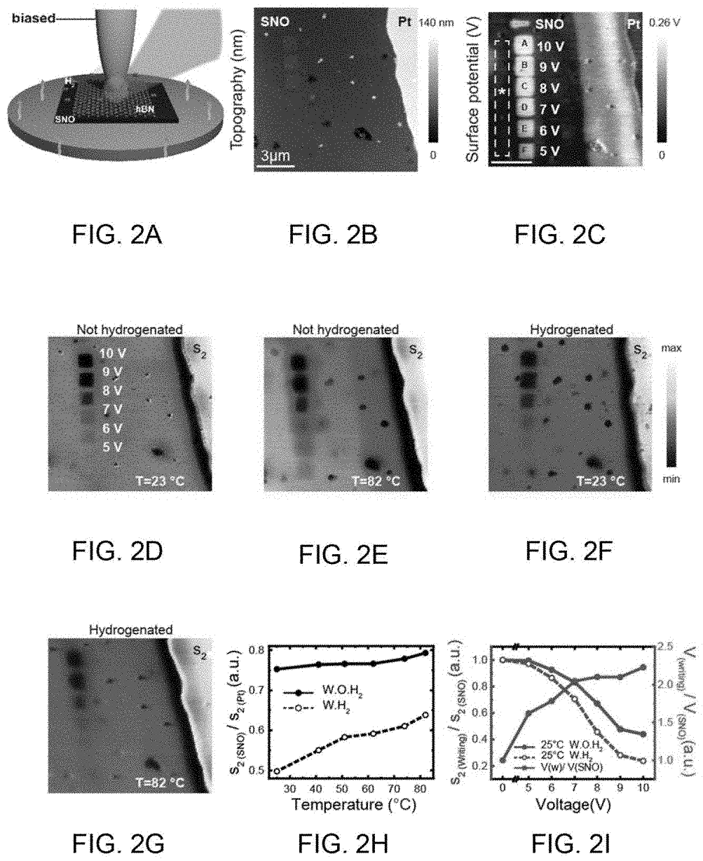

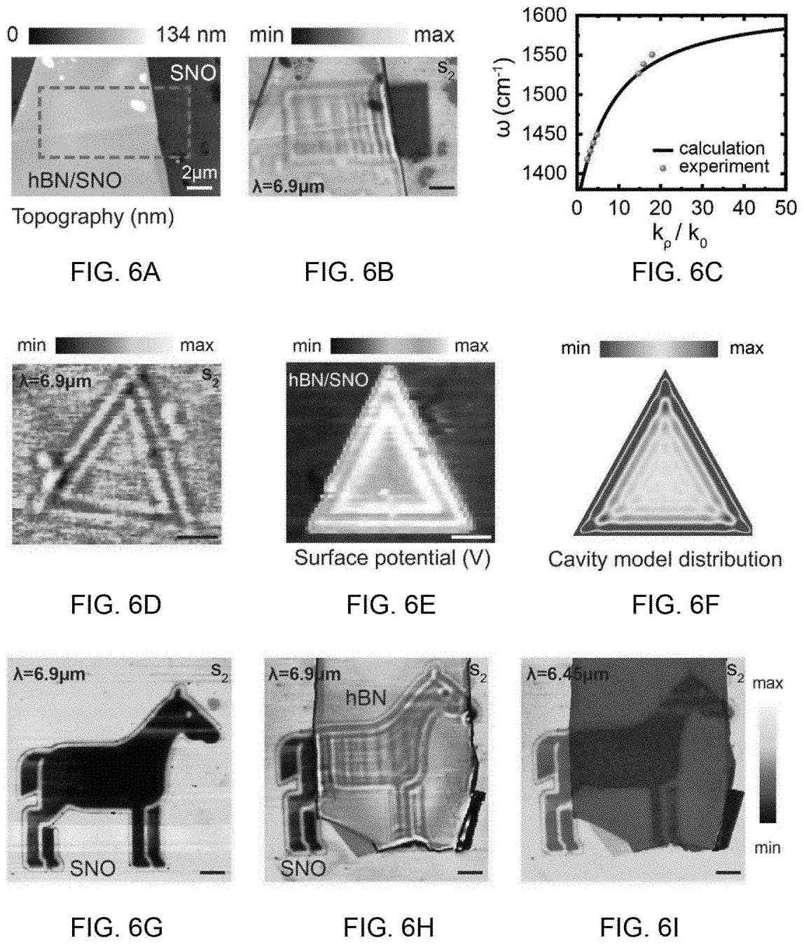

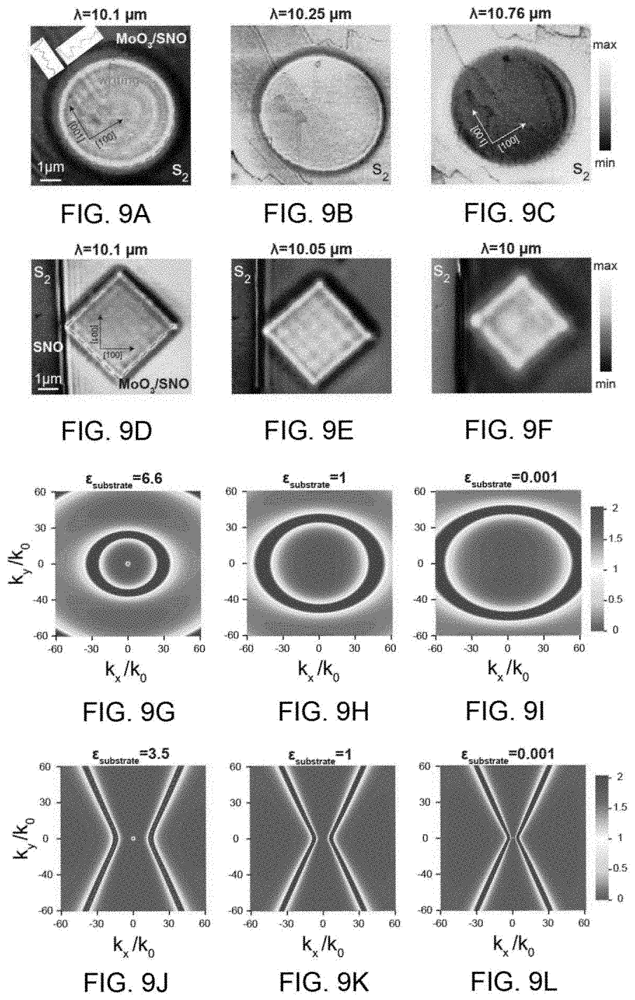

Accordingly, this disclosure reveals the promise of tunable correlated oxides metasurfaces for future configurable and tailorable nanophotonic technologies. The samples used for this work are SNO grown by magnetron co-sputtering on a LaAlO₃ substrate, and subsequently annealed in high pressure oxygen gas (see Methods for the detailed process). For example, a metasurface structure herein includes the correlated oxide SNO grown on a substrate LaAlO₃. Using conductive atomic force microscopy (c-AFM), we apply voltage on the surface so that a desired pattern is made. For example, the pattern can be either a geometrical shape consisting of several lines, a rectangular 12 μm*6 μm (FIG. 1B), a square 1 μm*1 μm (FIG. 2c), a triangle with 9 μm side (FIG. 6d, 6e), a circle 5 μm diameter (FIG. 9a-c) or a desirable shape like an animal figure (FIG. 6g-i). Applying a positive voltage results in a region with large resistivity on SNO (see Methods). Then a flake of van der Waals hyperbolic phononic exfoliable material like hBN or α-MoO₃ of desirable thickness (e.g. for hBN the thickness is 60 nm and α-MoO₃ is 120 nm) is transferred on top of the writing region on SNO surface using a homemade flake transfer setup²⁴.

Accordingly, a metasurface according to principles described herein may include correlated oxide on a substrate and a wiring pattern of predetermined geometric shape on the surface thereof. There is a flake of van der Waals phononic exfoliable material on top of the wiring pattern/region. The wiring pattern may be formed by c-AFM or any other appropriate methods²⁵.

Depending on the material which is transferred on SNO-Writing region, either a hyperbolic phonon polariton (hBN) or anisotropic phonon polariton (α-MoO₃), could be produced. The region of low conductivity can be manipulated in real-time either via temperature modulation or spontaneous hydrogenation too (FIG. 2, 3). For this step, first, the writing patterns are made, then using a homemade enclosure that is placed on a heater, we expose the SNO to H₂ (5%). To modulate the writing regions via temperature and capturing with s-SNOM, we used a homemade heating setup which is placed in the microscope, and we can measure through the near-field imaging.

Other correlated oxides, such as VO₂^{26 27,28}, NbO₂^{29 28} and correlated electron perovskite rare-earth nickelates RNiO₃²² (R is a rare-earth element such Ni, Sm) which have metal-insulator transition and LAO/STO (LaAlO₃ on SrTiO₃) with 2D electron gas confined between LAO and STO^{30,31} may be used in place of the SNO in any of the embodiments described herein. For example, using NNO the conductive pattern can be made using c-AFM and changed the surface to a desirable shape of insulating phase which is suitable for our device; however, on the LAO/STO surface c-AFM leads to an electron confinement between the layers so that a desirable shape of metallic/insulting phase can be made on the surface³².

FIGS. 1A-1D show a meta-structure consists of SNO-conductive written region and hBN flake. FIG. 1A shows topography; FIG. 1B is a surface potential (SKPM) image showing the lithography patterns made with SPM using 10 V; FIG. 1C is a picture of the flake transferred on the top of SNO including writing pattern of FIG. 1B; and FIG. 1D is a topography image of the pristine SNO with transferred hBN flake on the top.

FIGS. 1A and 1B show the topography and surface potential map of the region in which part of it (the rectangle in the middle of the image) is exposed to conductive writing. As shown in FIGS. 1C and 1D, next, a flake of hBN is transferred on top of that (FIGS. 1C and 1D). We first experimentally demonstrate a multimodal sub-wavelength hyperbolic metasurface by lateral nanoscale active manipulation of electronic phases of SNO.

To that end, we combine c-AFM and KPFM (Oxford Instruments) to generate and characterize nanoscale patterns of various levels of conductivities on SNO.

FIG. 2A-2I show tailoring local conductivity of SNO. FIG. 2A illustrates schematics of integrated s-SNOM and heating setup. FIG. 2B is an AFM topography image of pristine SNO. FIG. 2C shows KPFM surface potential image of conductive writing patterns on pristine SNO made by applying 5V-10V potential at the c-AFM tip, corresponding IR s-SNOM second harmonic near-field amplitude s₂ images at varying temperature. FIG. 2D is at T=23° C. (no H₂). FIG. 2E is at T=82° C. (no H₂), FIG. 2F is at T=23° C. after exposing to 5% H₂ gas while heating at 100° C. FIG. 2G is at T=82° C. after exposing to 5% H₂ gas while heating at 100° C., all imaged at λ=10.5 μm. FIG. 2H shows normalized amplitude s_{2(SNO)}/s_{2(Pt)} plots with and without H₂ exposure. FIG. 2I shows normalized amplitude s_{2(writing)}/s_{2(SNO)} with and without exposing to H₂ at T=25° C. and T=82° C. in the left axis and normalized potential plot of regions illustrated in FIG. 2C verses applied tip voltage in the right axis. All data points of plots were taken at regions with different potential (FIGS. 2A-F), shown in FIG. 2C, and all normalized to the values in the region showing with * in FIG. 2C. Scale bar is 3 μm.

To write square charge patterns on the SNO sample (topography shown in FIG. 2b), we applied strong local fields via c-AFM operated in contact mode, detection setpoint 0.2 V, scan rate 0.5 Hz, and spring constant of the tip 2 N/m. Subsequently, we map the surface potential of written areas using KPFM operated in tapping mode with an amplitude of 500 mV (see methods). The positive bias voltage in all writings led to a large potential compared to the pristine SNO as reflected in bright images in FIG. 2C. A large positive biased tip results in more desorption of surface adatoms and dissociates surface atoms, and the removal of oxygen from the SNO surface, providing a controllable route to manipulate the surface conductivity of SNO via the generation of oxygen vacancies³³. This charge writing behavior is also reversible with a negative bias³³.

We show in FIG. 2H a plot of normalized potential (the potential of the square writings (V_{writing}) divided by the potential of the pristine SNO (V_{SNO}), the surface potential difference of the patterned areas increases with the tip bias voltage commensurate with the change in local conductivity.

To quantitatively assess the local conductivity changes of the charge writing process, we performed s-SNOM imaging of the same area of the sample. S-SNOM maps local conductivity changes with high-sensitivity and high-spatial resolution only limited by the sharpness of the probe tip³⁴⁻³⁷. Focused infrared laser on a metalized cantilevered AFM tip with tapping frequency Ω interacts with the sample and the scattered light from this interaction is demodulated at higher harmonics nΩ of the tapping frequency and detected via phase modulation interferometer (see methods for more detail). The resulting s-SNOM amplitude images are shown in FIG. 2D-G were taken at 10 μm laser wavelength and show voltage dependence optical contrast. Such s-SNOM image contrast directly reflects local conductivity changes³⁶ of the sample where dark regions, i.e. the area written with positive biases, imply lower conductivity compared to the pristine (red) region (FIG. 2D-G) due to the removal of oxygen from the SNO surface. Increasing bias voltage results in decreasing the local near-field amplitude (local conductivity) as shown in the plot in FIG. 2i of the normalized amplitude (amplitude of the square writings (s_{2(writing)}) divided by the amplitude of the pristine SNO (s_{2(SNO)}). The combination of charge writing with c-AFM and optical imaging of local electronic changes by s-SNOM opens an exciting prospect for local conductivity lithographic patterning that could be of use in nanophotonics.

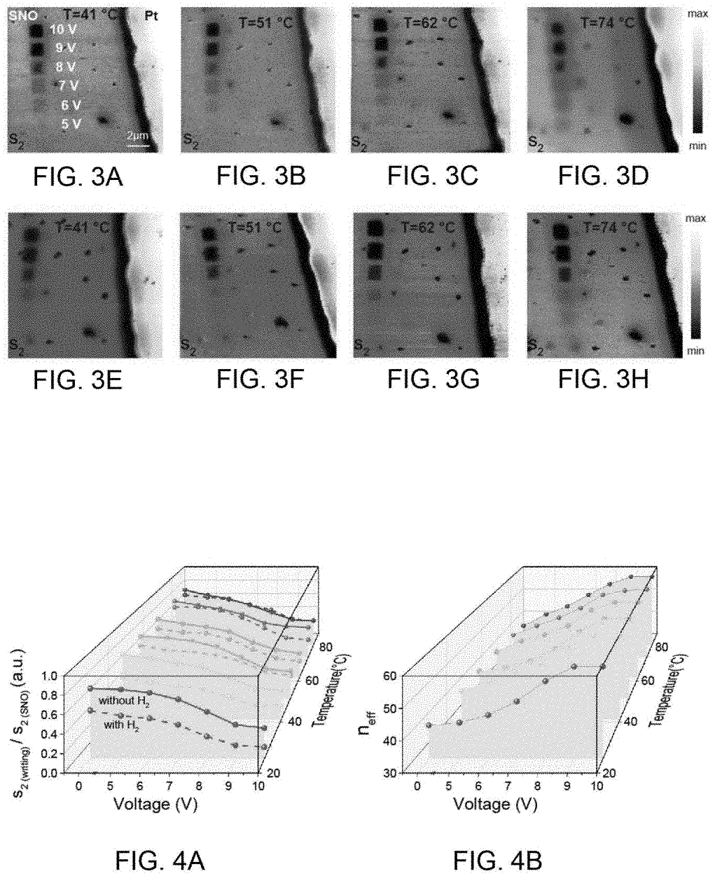

In addition to voltage dopant control, the local conductivity of SNO can be further tuned via temperature modulation or spontaneous hydrogenation, which also induces the metal-insulator phase transition MIT³³. We first investigate the temperature dependence of the pristine and written charge areas by mapping the IR near-field local response of the film. To that end, the sample was heated in situ at different temperatures on a custom-built heating stage integrated with the s-SNOM setup. After thermal equilibrium is reached (which is achieved by keeping the system at the selected temperature for 15 min), near-field images of the sample are taken. In FIGS. 2d and 1e we show two amplitude images taken at room (23° C.) and high temperature (82° C.) respectively (a series of images in different temperatures are shown in FIG. 3a-h).

FIGS. 3A-3H shows near-field images of SNO showing local conductivity changes at different temperatures. FIGS. 3A-H show second harmonic near-field amplitude s₂ images at different temperatures (no H₂). FIGS. 3G-L show second harmonic near-field amplitude s₂ images at different temperatures after exposing to 5% H₂ gas while heating at 100° C. all imaged at λ=10.5 μm.

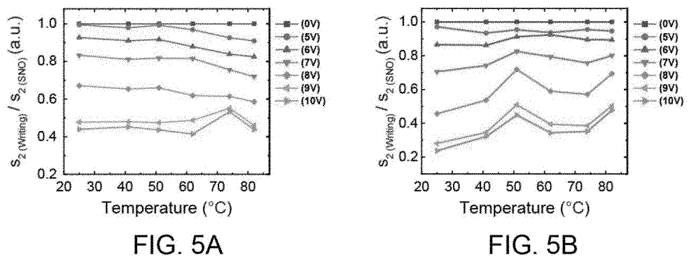

Unlike most metals, for correlated oxides like SNO increasing temperature or disorder does not hasten the electron scattering process and decrease the electronic conductivity. Instead, increasing temperature results in increasing conductivity²². This is captured in FIG. 2H, which shows a linear normalized near-field amplitude plot as a function of temperature revealing increasing amplitude, commensurate with increasing conductivity, as temperature increases. However, the charge written areas do not show a similar trend; instead, the measured change in normalized amplitude with temperature is weak (see FIGS. 5A-B) owing to reduced oxygen content.

FIGS. 5A-5B show conductive writing manipulation by temperature change compared to SNO. FIG. 5A shows normalized amplitude s_{2(writing)}/s_{2(SNO)} without exposing to H₂ for different temperatures. FIG. 5B shows normalized amplitude s_{2(writing)}/s_{2(SNO)} after exposing to 5% H₂ gas while heating at 100° C. for different temperatures.

These dissimilar changes in conductivity between the pristine and charge written areas remarkably resulted in making the invisible charge written marking at low voltage (e.g., 5 V) visible in s-SNOM amplitude image as shown in FIG. 2E. Oxygen vacancies affect the electron occupancy (donate electrons to Ni-site e_{g} orbitals) and electron-electron correlation energy and band gap in SNO, which modulated the MIT behavior. s-SNOM images provide a direct and facile way to monitor these modulations.

Hydrogen dopants provide another robust and sensitive route to dramatically modify the electronic phases of SNO¹⁶. We manipulate the local conductivity of pristine and written charge patterns of SNO by spontaneous hydrogen incorporation and then record in-situ the nanoscale changes via infrared s-SNOM imaging. The sample (that has written charge and pristine areas) is exposed to H₂ (using forming gas which is 5% H₂ and 95% N₂) for 30 minutes, while simultaneously heating the sample at 100° C. in a closed chamber. After hydrogen doping, the sample was cooled to room temperature and subsequent s-SNOM mapping was conducted as a function of temperature. Normalized amplitude s-SNOM plots of the pristine area of SNO as a function of temperature with and without hydrogen exposure are shown in FIG. 2H. A large resistance drop, compared to the pristine area, is observed in the hydrogenated sample at all temperatures due to modification of the electron configuration of, e.g., orbital of SNO²¹. Change in temperature also affects the charge written areas resulting in a large increase of conductivity at high temperatures (FIGS. 5A-B).

Nanoscale reconfigurable conductivity control in correlated oxides enables manipulation of sub-diffraction light-matter interaction and control of propagating nano-confined fields.

FIGS. 4A-4B illustrate local conductivity manipulation by controlling oxygen dopants via applied field, temperature, and hydrogen incorporation. FIG. 4A is a three dimensional (3D) plot showing changes in normalized amplitude s_{2(writing)}/s_{2(SNO)} (z-axis) as a function voltage (x-axis) and temperature (y-axis) on a pristine and hydrogen doped SNO samples. Dashed lines represent data on a sample exposed to 5% H₂ and solid lines represent data on the pristine sample.

FIG. 4A summarizes the three nobs we described above, which enable nanoscale tuning of local conductivity of SNO: oxygen vacancy control via tip voltage changes (x-axis), temperature (y-axis), and hydrogenation of the sample. Dashed lines represent normalized amplitude s_{2(writing)}/s_{2(SNO)} on a sample exposed to 5% H₂, and solid lines represent data on the pristine sample measured at various temperatures (shown by the different colors). As a case study to show the applicability of large tunability brought by the patterned SNO metasurfaces employing the various nobs, we theoretically consider the polaritons at [100] direction in an alpha-phase molybdenum trioxide (α-MoO₃) slab sandwiched between air and SNO, at the frequency of ω=990.09 μm (see FIG. 4b). The α-MoO₃ is anisotropic van der Waals material, which has recently been widely explored to its polaritonic characters³⁸⁻⁴¹.

FIG. 4B illustrates a ratio of polariton wavevector to free space photons wavevector versus voltage and temperature. Here, we plot in FIG. 4B the effective index, n_{eff}, defined as k_{ρ}/k₀ along [100] direction where k_{ρ} is the in-plane momentum of PhPs and k₀=2π/λ is the momentum of light in free space with λ being the free-space wavelength of light. The 3d plot shows how n_{eff}, can vary via modifications of external effects (temperature, voltage, and hydrogen doping) of SNO, which corroborates the unprecedented capability and promise of tunable polaritonics with correlated oxide meta-structures and which will be further demonstrated below.

Tunable Polaritonics with SNO-hBN Architectures

We now demonstrate the nanoscale hyperbolic devices based on several different SNO-hBN hybrid metasurfaces via introducing the spatially localized dielectric variations of patterned geometries. We used isotopically hBN (%99 enriched)^{3,42,43}, a natural hyperbolic medium that supports low-loss hyperbolic phonon polaritons (HPhPs)⁴³ exfoliated and then transferred on top of SNO surface. Various size and shape patterns were written by applying 5V-10V potential at the c-AFM tip. To show the dispersion engineering, we first probe the polariton wavelength as a function of incident frequency with dielectric-like SNO, and then quantitatively extract modified HPhP dispersion.

FIGS. 6A-6I show several meta-structures. FIG. 6A is a topography image of pristine SNO. A lithography pattern is done by applying 10 V potential at the c-AFM tip, and a flake of 60 nm hBN (˜99% enriched) is transferred on the top. FIG. 6B is an IR s-SNOM showing a second harmonic near-field amplitude s₂ image. FIG. 6C shows measurement of the dispersion relation of HPhPs in 60 nm thick hBN on the SNO. FIG. 6D is a second harmonic near-field amplitude s₂ image of a 60 nm hBN flake transferred on a triangular cavity lithography pattern made by applying 10V potential c-AFM tip. FIG. 6E shows corresponding KPFM surface potential images, and FIG. 6F shows simulation result (see methods) of the devices of FIG. 6D. s-SNOM second harmonic near-field amplitude s₂ images of a lithography pattern on SNO written by applying 10V potential at the c-AFM tip. prior transferring a hBN flake (FIG. 6G) and with a 50 nm thick hBN flake on the top showing polaritons at 6.9 μm (FIG. 6H), and at 6.45 μm (FIG. 6I).

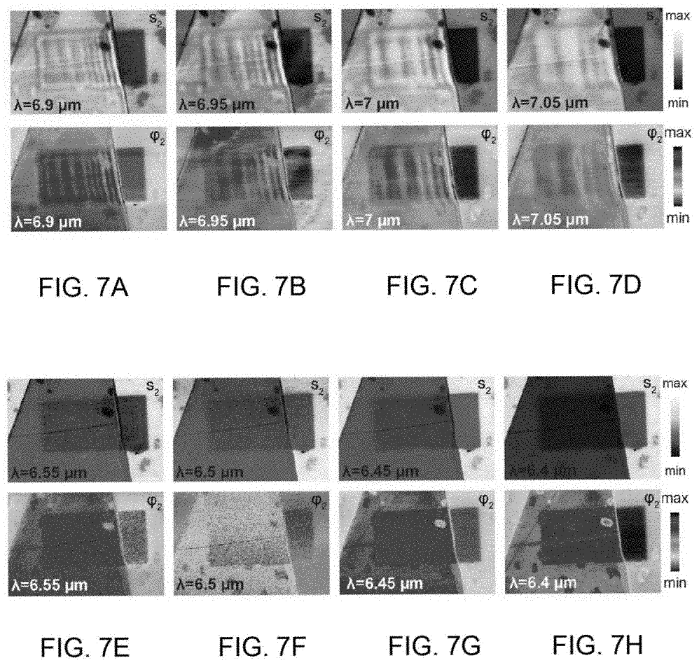

The lithography writing pattern (green dashed lines in FIG. 6A) on the surface of SNO was made by applying 10V using the c-AFM tip in a rectangular shape (6 μm×12 μm); a 60 nm thick hBN (%99 enriched) was then transferred on its top covering both the writing and SNO pristine regions. We imaged the HPhPs in the hBN using IR laser emitted by quantum cascade laser source focused on s-SNOM tip (methods). Here, the AFM tip is used to launch polaritons and collect the polaritons reflected at local domain walls between two different phases of SNO. The evanescent fields induced at the tip apex launches HPhPs that propagate radially outward from the tip, confined within the volume of the hBN flake. Upon reaching the local pristine/charge written boundary, the HPhP is reflected and interferes with the outgoing mode to generate a pattern imaged by the s-SNOM tip as shown in FIG. 6B (a series of images in different wavelengths are shown in FIGS. 7A-H).

FIGS. 7A-7H show second harmonic near-field amplitude s₂ and phase Ω₂ images of the SNO-hBN structure (device of FIG. 6B) at 6.9 μm (FIG. 7A), 6.95 μm (FIG. 7B), 7 μm (FIG. 7C), 7.05 μm (FIG. 7D), 6.55 μm (FIG. 7E), 6.5 μm (FIG. 7F), 6.45 μm (FIG. 7G), and 6.9 μm (FIG. 7H). In order to capture the dispersion of the propagating HPhPs on the SNO surface, several incident laser frequencies are exploited. Accordingly, the dispersion relation is obtained and shown as red dots in FIG. 6C, which agrees well with an analytical model (solid black line in FIG. 6C, see methods).

Next, we show that the polariton propagation in cavities can be examined using the reconfigurable SNO-hBN interfaces. Previous studies using the patterned hBN such as nanoribbons^{44,45} and nanocones⁴⁶ can create resonant polaritons but require the demanding fabrications of insulating hBN. Here, we offer an alternative and reconfigurable facile patterning approach to devise the polariton cavity, using the spatially patterned SNO with a large contrast of conductivities. To this end, we realized a triangular cavity by applying 10V with the c-AFM tip on SNO.

FIGS. 3D and 3E show the near-field amplitude s₂ and surface potential SKPM images of the cavity, which agree with our numerical modelings (FIG. 6F). We model the polariton distribution in a cavity, is an example of triangle shape, by the interference of the polaritons reflected at the edges of the substrate cavity. The detailed modeling technique is provided in the method section. Our results also show a sharp difference of polaritons propagating into and out to triangle cavity (FIG. 6D), further confirming the distinguished properties of SNO in a different phase and hence the large configurability of polaritons. Moreover, different near-field images can be arbitrarily created via our modified SNO. FIGS. 6G-6I show a pattern written on SNO and imaged at 6.9 μm laser wavelength with and without hBN flake (thickness 50) on top of SNO, demonstrating desired metasurfaces by imaging at polariton wavelength (FIG. 6H) or outside the range of HPhP wavelength (FIG. 6I). These examples show that a simple tip-based high-resolution patterning of the oxide surface, instead of complicated fabrication of vdW materials themselves or substrates could provide a tailorable polariton cavity and other desired designs, allowing us to tailor the on-demand configuration of polariton configurations.

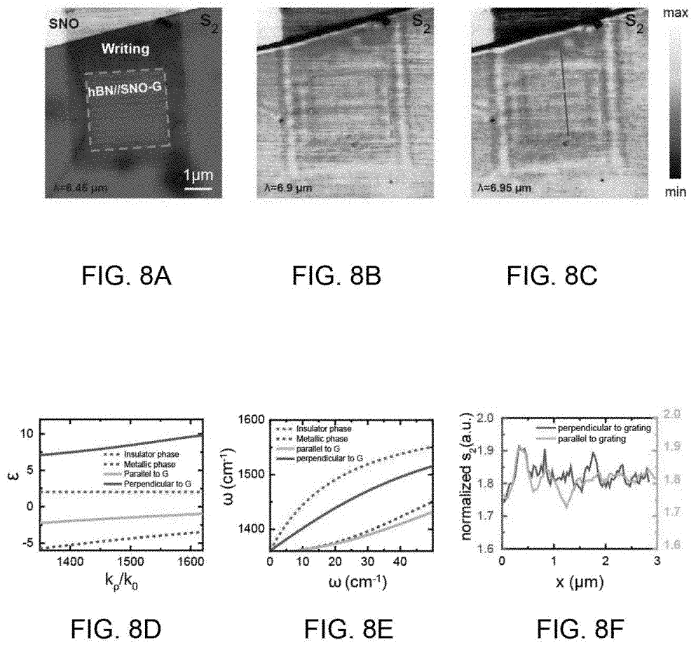

FIGS. 8A-8F show anisotropic propagation of polaritons in hBN. Referring to FIGS. 8A-8F, IR s-SNOM second harmonic near-field amplitude s₂ images of hBN/SNO-G are shown at 6.45 μm (FIG. 8A), 6.9 μm (FIG. 8B), and 6.95 μm (FIG. 8C), in which the blue dashed line shows where grating starts. FIG. 8D shows the effective permittivity of the substrate, in which the red, blue, cyan, and green lines represent the permittivity of SNO in insulator phase, SNO in metallic phase, SNO-G parallel to ribbon and SNO-G perpendicular to ribbon, respectively. FIG. 8E shows the calculated polariton momentum with the substrate of insulator SNO (red dashed line), metallic SNO (blue dashed line), along SNO-G (cyan solid line) and perpendicular to SNO-G (green solid line) directions. FIG. 8f shows an amplitude s₂ line profile as indicated in FIG. 8C, with green and cyan lines showing polariton propagating parallel and perpendicular to the grating.

Tunable Polaritonics with SNO—MoO₃ Architectures

Tremendous recent interest has been focused on in-plane anisotropic PhPs, in materials of α-MoO₃^{38,40,41}, α-V₂O₅⁴⁷, and others⁴⁸. The dispersion of those materials can be engineered by intercalation^{47,49,50} or the twist^{41, 51}. Here, we point out another avenue of tunable dispersion of in-plane anisotropic PhPs via our largely tunable correlated oxide metasurfaces, a reconfigurable substrate that provides nanoscale on-demand dielectric patterns enabling the active manipulation of nano-confined fields. The structures were made by c-AFM with 10V voltages, and α-MoO₃ is exfoliated and transferred on top of them. FIGS. 9A-9L show hyperbolic polaritons in α-MoO₃ at different wavelengths.

FIGS. 9A-9L shows IR s-SNOM second harmonic near-field amplitude s₂ images of pristine α-MoO₃—SNO at λ=10.1 μm (FIG. 9A), λ=10.25 μm (FIG. 9B), and λ=10.76 (FIG. 9C). The lithography pattern (a circle with 5 μm diameter) was made by applying 10 V potential at the c-AFM tip, and a flake of 120 nm α-MoO₃ is transferred on the top at part of the devices shown at FIGS. 9A, 9B and 9C. FIGS. 9D-9F further shows IR s-SNOM second harmonic near-field amplitude s₂ images of pristine α-MoO₃—SNO at 2=10.1 (FIG. 9D), λ=10.05 μm (FIG. 9E), and λ=10 μm (FIG. 9F). The lithography pattern (a square with 4 μm side) was made by applying 10 V potential at the c-AFM tip, and a flake of 120 nm α-MoO₃ is transferred on the top at of the devices of FIGS. 9A, 9B and 9C. FIGS. 9G-i show the dispersion of polaritons of 100 nm thick α-MoO₃ on top of the correlated oxide metasurface with different permittivity, at the frequency of 990.09 cm⁻. FIGS. 9J-L show the dispersion of hyperbolic polaritons of 100 nm thick α-MoO₃ on top of correlated oxide metasurfaces with different permittivity, at the frequency of 900.9 cm⁻.

In FIG. 9A, we observed the elliptical shape with the largest PhPs wavelength along the [001] (blue plot in FIG. 9A) and the smaller value along the [100] (green plot in FIG. 9A). More importantly, as we go to the L-RB (around 10.76 μm) the interference patterns show an almond shape (FIG. 9C) with the largest wavelength along the [100] and almost no propagation along the orthogonal [001] direction, which is in agreement with the latest findings³⁸. In those images, one could notice that HPhPs mostly propagate inside the dielectric-phase SNO, being confined, while the dramatic differences of the fringe periodicity are observed inside and outside of SNO circles. Furthermore, in FIGS. 9D-9F we show hyperbolic modes on square patterns that are twisted 45° angle from the sample axis [001] as shown in FIG. 9D for the 10.1 μm, 10.05 μm, and 10 μm laser wavelength, respectively. HPH reflecting from edges propagate with almost the same wavelength at L-RB, while that in twisted angle of 45° with respect to the [001] axis the anisotropy is not seen, exhibiting the similar patterns and behaviors with recent findings using the α-MoO₃ nanocavities⁴⁰ and suggesting the realized nanocavities using the shaped dielectric substrate.

Our correlated oxide metasurfaces have unlocked the broad opportunities of tunable devices. To further demonstrate the great promise of its application in tunable polaritonics, we plotted the analytical isofrequency dispersion of polariton of 100 nm thick α-MoO₃ on top of correlated oxide metasurfaces with different values of permittivity, as shown in FIGS. 9G-9L. The large changes of momentum in different reststrahlen bands of α-MoO₃ are observed, suggesting the various confinement of polaritons and different levels of light-matter interactions. Furthermore, the topological transitions may also be available if one further extends the possible permittivity range to the negative values, as demonstrated in recent findings of α-MoO₃ on top of negative-permittivity substrate^{52,53}, which could be studied in future work.

Methods

Scanning probe microscopy (SPM) is a general term that includes techniques with AFM (a sharp metal probe is used in tapping mode and contacted mode). We used the Cypher AFM (Oxford instrument) to acquire c-AFM and SKPM. In order to make the lithography (writing) pattern using c-AFM (FIGS. 1A-D, 2A-2I, and 3A-3H), a contacted mode AFM was performed while applying 5V-10V through a metal Ti/Ir coated tip (Asyelectric.01-R2 from Oxford instrument). In c-AFM, the current is passed through the tip and into a transimpedance amplifier, and it converts current to a voltage.

Scanning Kelvin probe microscopy (SKPM) is a technique that detects the potential difference between the probe and the sample. This technique is based on the AC bias applied to the tip to produce an electric force on the cantilever, which is proportional to the potential difference between the tip and the sample. Using an AC bias, the probe is driven electrically and the potential difference between the tip and the sample causes the probe to oscillate. These oscillations are canceled by a potential feedback loop, and the voltage required to match the probe to the sample is recorded as the surface potential in the software.

A combination of s-SNOM and nano-FTIR is used to acquire topography, near-field images and IR nano-spectra of SNO sample prepared by PVD on LaAlO₃ substrates. The experimental setup (FIG. 1B, neaspec co.) is based on a tapping mode AFM with a cantilevered metal-coated tip that oscillates at a resonance frequency Ω˜280 kHz and tapping amplitude of ˜100 nm. Either a coherent broadband infrared beam in the frequency range 700-2100 cm⁻¹ (for nano-FTIR) or a monochromatic IR laser (for s-SNOM) is focused by a parabolic mirror to the tip. For nano-FTIR operation, the backscattered near-field light from the tip-sample junction is detected via mixing with an asymmetric Fourier transform Michelson interferometer. This detection method enables recording of both the amplitude s(ω) and phase φ(ω) spectra of the backscattered light. To extract background free local near-fields, the detector signal is demodulated at a higher harmonic nΩ of the tip mechanical resonance frequency Ω. Normalized amplitude (sₙ₍ₛₐₘₚₗₑ₎/s_{n(reference)}) and phase (φₙ₍ₛₐₘₚₗₑ₎−φ_{n(reference)}) IR near-field spectra are acquired by first taking reference spectrum on a reference area (silicon is used in these experiments), followed by taking spectra at desired positions of the sample. (see Methods for details).

Materials Synthesis

SNO: SmNiO₃ thin films were prepared using magnetron co-sputtering from pure Sm and Ni target at room temperature. The substrates were cleaned using acetone and isopropanol and dried by blowing N₂ gas. During deposition, the chamber was maintained at 5 mtorr with flowing 40 sccm Ar and 10 sccm O₂ gas mixture. The sputtering power was set as 170 W (RF) for Sm and 85 W (DC) for Ni to obtain stochiometric ratio. The as deposited films were subsequently annealed at 500° C. for 24 h in high pressure oxygen gas at 1400 psi to forming the perovskite phase.

HBN: The hexagonal boron nitride crystal flakes were grown at atmospheric pressure using an iron-chromium solvent, isotopically-enriched boron-10 (>99% ¹⁰B) and nitrogen. The crystal growth process was previously described in detail⁵⁴.

MoO₃: Bulk α-MoO₃ crystals were synthesized via physical vapor deposition. Commercial MoO₃ powder (Sigma-Aldrich) was evaporated in a horizontal tube furnace at 785° C. and bulk crystals were deposited at 560° C. The deposition was carried out in a vacuum environment, with argon as the carrier gas for vapor transport (1 Torr). Subsequently, the bulk crystals were mechanically exfoliated using adhesive tape and flakes were transferred on to 300 nm SiO2 on Si substrates for characterization.

Numerical modeling: To model the polaritonic distribution at position \vec{r}, we take the linear combination of the polaritons launched by the tip and that reflected by the edge, which should follow⁴⁰

$$\text{?}$$

$$\text{?} \text{indicates text missing or illegible when filed}$$

Here, the first term is the onsite polariton signals launched by the tip, and |R|e^{iϕ}^{_{R}} denote the reflection characteristic at the edge by its amplitude (|R|) and phase parameters (ϕ_{R}). The addition propagation length accounting for the polariton propagating to and reflected by the edge is included in the term e^{-2ik}^{ₜ}^{d}^{ⱼ} where dⱼ is the distance between the examination position and the edge and kₜ being in-plane complex polariton momentum. Here, for simplicity, we assume that |R|=1 and the reflection phase shift is ϕ_{R}=1.5π, which is reasonable and gives a better fitting in main text.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

The structures, compositions and methods of the appended claims are not limited in scope by the specific structures, compositions and methods described herein, which are intended as illustrations of a few aspects of the claims and any structures, compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the structures, compositions and method steps also are intended to fall within the scope of the appended claims, even if not specifically recited. Thus, a combination of steps, elements, structures, components, or constituents may be explicitly mentioned herein; however, other combinations of steps, elements, structures, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A device having a metasurface, comprising:
a substrate;
a patterned correlated oxide on the substrate; and
a van der Waals phononic exfoliable material on the patterned correlated oxide.

2. The device of claim 1, wherein the van der Waals phononic exfoliable material is a flake thereof.

3. The device of claim 1, wherein the van der Walls phononic exfoliable material comprises hexagonal boron nitride (h-BN) and/or Molybdenum Trioxide (α-MoO₃).

4. The device of claim 3, wherein the van der Walls phononic exfoliable material comprises a layer of 100-120 nm for α-MoO₃.

5. The device of claim 3, wherein the van der Walls phononic exfoliable material comprises a layer of 50-60 nm for hBN.

6. The device of claim 1, wherein the correlated oxide comprises samarium nickelate (SmNiO₃)(SNO), vanadium dioxide (VO₂), niobium dioxide (NbO₂) and/or correlated electron perovskite rare-earth nickelates, such as RNiO₃, where R is a rare earth element.

7. The device of claim 1, wherein a pattern of the patterned correlated oxide is changeable by application of a predetermined voltage.

8. The device of claim 5, wherein the pattern may be changed to a new pattern by the application of the predetermined voltage in the new pattern.

9. The device of claim 1, wherein the patterned correlated oxide includes hydrogen dopant.

10. The device of claim 1, wherein the substrate comprises LaAlO₃

11. The device of claim 1, wherein nanoscale reconfigurable conductivity is controllable by the application of a predetermined voltage.

12. The device of claim 1 enabled for manipulation of sub-diffraction light-matter interaction and/or control of propagating nano-confined fields by the application of a predetermined voltage.

13. A method of controlling nanoscale conductivity in a device according to claim 1, the method comprising controlling oxygen dopants in the correlated oxide by applied electromagnetic field, temperature and/or hydrogen incorporation.

14. A method of manipulating sub-diffraction of light-matter interaction in a device according to claim 1, the method comprising: changing a pattern of the pattern of the correlated oxide by application of applied electromagnetic field, temperature and/or hydrogen incorporation.

15. A method of controlling propagating nano-confined fields in a device according to claim 1, the method comprising: changing a pattern of the pattern of the correlated oxide by application of applied electromagnetic field, temperature and/or hydrogen incorporation.

16. A method of propagating phonon polaritons (PhPs) via a metasurface device according to claim 1.

17. A method of making a device having a correlated oxide metasurface, the method comprising;
providing a substrate;
depositing a correlated oxide on the substrate;
patterning the correlated oxide via lithography; and
depositing a van der Waals phononic exfoliable material over the patterned correlated oxide.

18. The method of claim 17, further comprising changing the pattern of the correlated oxide by the application of a predetermined voltage.

19. The method of claim 17, wherein the van der Waals phononic exfoliable material is a flake thereof.

20. The method of claim 17, wherein the van der Walls phononic exfoliable material comprises hexagonal boron nitride (h-BN) and/or Molybdenum Trioxide (α-MoO₃).

21. The method of claim 20, wherein the van der Walls phononic exfoliable material comprises a layer of 100-120 nm for α-MoO₃.

22. The method of claim 20, wherein the van der Walls phononic exfoliable material comprises a layer of 50-60 nm for hBN.

23. The method of claim 17, wherein the correlated oxide comprises samarium nickelate (SmNiO₃)(SNO), vanadium dioxide (VO₂), niobium dioxide (NbO₂) and/or correlated electron perovskite rare-earth nickelates, such as RNiO₃, where R is a rare earth element.

24. The method of claim 17, wherein the patterned correlated oxide includes hydrogen dopant.
